(19) United States
(12) Patent Application Publication
(10) Pub. No.: US 2015/0363370 A1
(43) Pub. Date: Dec. 17, 2015

(54) System and Method of Email Document Classification

(71) Applicant: Christopher Tambos, New York, NY (US)

(72) Inventor: Christopher Tambos, New York, NY (US)

(21) Appl. No.: 14/737,576

(22) Filed: Jun. 12, 2015

Related U.S. Application Data
(60) Provisional application No. 62/011,178, filed on Jun. 12, 2014.

(51) Int. Cl. G06F 17/22; G06F 17/30

(52) U.S. Cl. CPC G06F 17/2264; G06F 17/30896; G06F 17/2247

(57) ABSTRACT

System and method of email document classification involving the removal of disclaimers from consideration in the classification process. The method first removes all html code and coverts the text to a standardized all lower case font. One or more matching strings are run on the content. In an alternative embodiment, disclaimers are identified and removed. One or more matching disclaimer strings are run on the document after the font and text conversion. After all disclaimer strings have been run, the document has either been unchanged, or the disclaimer sections removed per the instructions of the strings. One or more matching strings for classifying the document are then run before the process ends and the document is classified.

### CROSS REFERENCE TO RELATED APPLICATIONS

This application claims priority from U.S. Patent Application Ser. No. 62/011,178, entitled “System and Method of Email Document Classification”, filed on Jun. 12, 2014. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention pertains to generally to electronic email document classification. The present invention more specifically relates to electronic email document classification of emails for storage and retrieval involving the removal of disclaimers from consideration in the classification process.

### BACKGROUND OF THE INVENTION

Organizations and individuals are incessantly inundated by a plethora of electronic data in the form of email. Much of this information is communicated in the form of electronic mail (referred to herein as “e-mail” or “email”). Since its introduction as a form of communication, emails have become one of the most preferred methods of communication, often preferred over phone calls, and meetings. As a result, a significant portion of an email user's workday is spent in reading, writing, and organizing emails.

Email users may feel overwhelmed by the amount of email they receive Some email clients may allow rules to be manually setup to provide some organization; however manual setup is generally time consuming and/or otherwise frustrating to email users.

Thus, there is a need for a method that assists organizations, employees, and any email user in managing, documenting, storing, and retrieving their emails in an efficient and effective manner.

### DEFINITIONS

Unless stated to the contrary, for the purposes of the present disclosure, the following terms shall have the following definitions:

“Application software” is a set of one or more programs designed to carry out operations for a specific application. Application software cannot run on itself but is dependent on system software to execute. Examples of application software include MS Word, MS Excel, a console game, a library management system, a spreadsheet system etc. The term is used to distinguish such software from another type of computer program referred to as system software, which manages and integrates a computer's capabilities but does not directly perform tasks that benefit the user. The system software serves the application, which in turn serves the user.

The term “app” is a shortening of the term “application software”. It has become very popular and in 2010 was listed as “Word of the Year” by the American Dialect Society

“Apps” are usually available through application distribution platforms, which began appearing in 2008 and are typically operated by the owner of the mobile operating system. Some apps are free, while others must be bought. Usually, they are downloaded from the platform to a target device, but sometimes they can be downloaded to laptops or desktop computers.

“API” In computer programming, an application programming interface (API) is a set of routines, protocols, and tools for building software applications. An API expresses a software component in terms of its operations, inputs, outputs, and underlying types. An API defines functionalities that are independent of their respective implementations, which allows definitions and implementations to vary without compromising each other.

“Email” or “electronic messages” is defined as a means or system for transmitting messages electronically as between computers or mobile electronic devices on a network.

“Email Client” or more formally mail user agent (MUA) is a computer program used to access and manage a user's email. A web application that provides message management, composition, and reception functions is sometimes also considered an email client, but more commonly referred to as webmail.

“EMS” is an abbreviation for email service providers, which are companies that provide email clients enabling users to send and receive electronic messages.

“Electronic Mobile Device” is defined as any computer, phone, smartphone, tablet, or computing device that is comprised of a battery, display, circuit board, and processor that is capable of processing or executing software. Examples of electronic mobile devices are smartphones, laptop computers, and table PCs.

“GUI”. In computing, a graphical user interface (GUI) sometimes pronounced “gooey” (or “gee-you-eye”)) is a type of interface that allows users to interact with electronic devices through graphical icons and visual indicators such as secondary notation, as opposed to text-based interfaces, typed command labels or text navigation. GUIs were introduced in reaction to the perceived steep learning curve of command-line interfaces (CLIs), which require commands to be typed on the keyboard.

The Hypertext Transfer Protocol (HTTP) is an application protocol for distributed, collaborative, hypermedia information systems. HTTP is the foundation of data communication for the World Wide Web. Hypertext is structured text that uses logical links (hyperlinks) between nodes containing text. HTTP is the protocol to exchange or transfer hypertext.

The Internet Protocol (IP) is the principal communications protocol in the Internet protocol suite for relaying datagrams across network boundaries. Its routing function enables internetworking, and essentially establishes the Internet.

An Internet Protocol address (IP address) is a numerical label assigned to each device (e.g., computer, printer) participating in a computer network that uses the Internet Protocol for communication. An IP address serves two principal functions: host or network interface identification and location addressing.

An Internet service provider (ISP) is an organization that provides services for accessing, using, or participating in the Internet.

A “mobile app” is a computer program designed to run on smartphones, tablet computers and other mobile devices, which the Applicant/Inventor refers to generically as “a computing device”, which is not intended to be all inclusive of all computers and mobile devices that are capable of executing software applications.

A “mobile device” is a generic term used to refer to a variety of devices that allow people to access data and information from where ever they are. This includes cell phones and other portable devices such as, but not limited to, PDAs, Pads, smartphones, and laptop computers.

A “module” in software is a part of a program. Programs are composed of one or more independently developed modules that are not combined until the program is linked. A single module can contain one or several routines or steps.

A “module” in hardware, is a self-contained component. “REC” or “recipient email client” is the computer program used to access and manage a user's email when that user is the recipient of the email being tracked or monitored.

“RTS” or “remote tracking server” is a third party software module stored on and executed by a computer that communicates with a recipient email client to gather information about specific emails being received.

A “software application” is a program or group of programs designed for end users. Application software can be divided into two general classes: systems software and applications software. Systems software consists of low-level programs that interact with the computer at a very basic level. This includes operating systems, compilers, and utilities for managing computer resources. In contrast, applications software (also called end-user programs) includes database programs, word processors, and spreadsheets. Figuratively speaking, applications software sits on top of systems software because it is unable to run without the operating system and system utilities.

A “software module” is a file that contains instructions. “Module” implies a single executable file that is only a part of the application, such as a DLL. When referring to an entire program, the terms “application” and “software program” are typically used. A software module is defined as a series of process steps stored in an electronic memory of an electronic device and executed by the processor of an electronic device such as a computer, pad, smart phone, or other equivalent device known in the prior art.

A “software application module” is a program or group of programs designed for end users that contains one or more files that contains instructions to be executed by a computer or other equivalent device.

A “smartphone” (or smart phone) is a mobile phone with more advanced computing capability and connectivity than basic feature phones. Smartphones typically include the features of a phone with those of another popular consumer device, such as a personal digital assistant, a media player, a digital camera, and/or a GPS navigation unit. Later smartphones include all of those plus the features of a touchscreen computer, including web browsing, wideband network radio (e.g. LTE), Wi-Fi, 3rd-party apps, motion sensor and mobile payment.

URL is an abbreviation of Uniform Resource Locator (URL), it is the global address of documents and other resources on the World Wide Web (also referred to as the “Internet”).

A “User” is any person registered to use the computer system executing the method of the present invention.

In computing, a “user agent” or “useragent” is software (a software agent) that is acting on behalf of a user. For example, an email reader is a mail user agent, and in the Session Initiation Protocol (SIP), the term user agent refers to both end points of a communications session. In many cases, a user agent acts as a client in a network protocol used in communications within a client-server distributed computing system. In particular, the Hypertext Transfer Protocol (HTTP) identifies the client software originating the request, using a “User-Agent” header, even when the client is not operated by a user. The SIP protocol (based on HTTP) followed this usage.

A “web application” or “web app” is any application software that runs in a web browser and is created in a browser-supported programming language (such as the combination of JavaScript, HTML and CSS) and relies on a web browser to render the application.

A “website”, also written as Web site, web site, or simply site, is a collection of related web pages containing images, videos or other digital assets. A website is hosted on at least one web server, accessible via a network such as the Internet or a private local area network through an Internet address known as a Uniform Resource Locator (URL). All publicly accessible websites collectively constitute the World Wide Web.

A “web page”, also written as webpage is a document, typically written in plain text interspersed with formatting instructions of Hypertext Markup Language (HTML, XHTML). A web page may incorporate elements from other websites with suitable markup anchors.

Web pages are accessed and transported with the Hypertext Transfer Protocol (HTTP), which may optionally employ encryption (HTTP Secure, HTTPS) to provide security and privacy for the user of the web page content. The user's application, often a web browser displayed on a computer, renders the page content according to its HTML markup instructions onto a display terminal. The pages of a website can usually be accessed from a simple Uniform Resource Locator (URL) called the homepage. The URLs of the pages organize them into a hierarchy, although hyperlinking between them conveys the reader's perceived site structure and guides the reader's navigation of the site.

### SUMMARY OF THE INVENTION

Currently there are various reasons why one might want to classify email documents such as email. One reason is to monitor for inappropriate email communications. But utilizing systems such as a Lexicon or keyword analysis or machine learning classifiers can be problematic particularly because email in business and elsewhere sometimes contains content that is noise for these classification systems. This causes very inaccurate results.

The present invention is a method that teaches a solution to this problem which involves automatically removing the legal disclaimers from email and other communications that would benefit from this method resulting in a simpler and more accurate classification of the email or other electronic email document.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is illustrates a typical email format and content structure; and

FIG. 2 is a flow chart illustrating the process steps of the method of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

The physical apparatus required to enable one embodiment of the present invention includes a web server; a web portal interface; a multi-user network; and an application server. Thus, the method of the present invention may also be recorded onto a CD, or any other recordable medium as well as being delivered electronically from a database to a computer, wherein the method embodied by the software that is recorded is then executed by a computer for use and transformation of the Internet browser and its contents. Now referring to the Figures, the embodiment of the method of the present invention is shown.

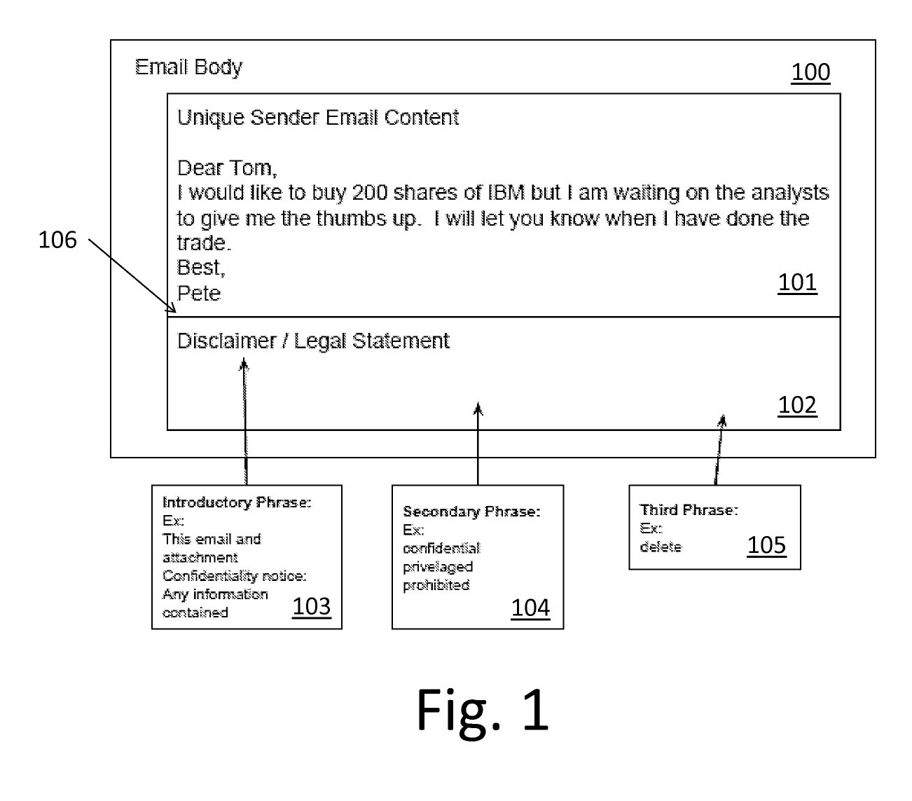

FIG. 1 illustrates the typical format of an email, wherein the email body 100 is comprised of unique sender email content 101 followed by a line break, signature, or other formatting commonality denoting where the message ends 106 and where a disclaimer 102 might begin. A legal disclaimer 102 typically contains common or generic introductory phrases or words 103 such as “this email and attachment”; “confidentiality notice”; and “any information contained.” The body of a disclaimer also typically contains general or generic secondary words or phrases 104 such as “confidential”, “privileged”, and “prohibited”. A third phrase 105 is also common included which directs an action such as “delete”, or “notify”.

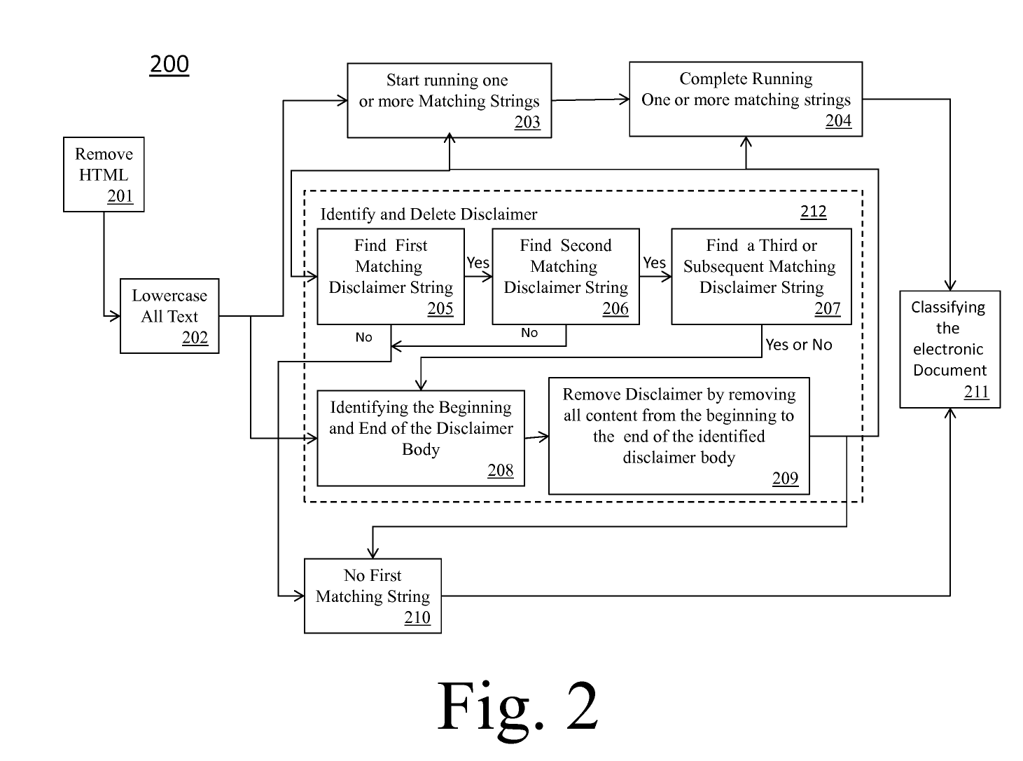

Now referring to FIG. 2, the method first removes all html code 201 and coverts the text to a standardized all lower case font 202. One or more matching strings 205, 206, 207 are run on the content 203. In an alternative embodiment, disclaimers are identified 208 and removed 209 before matching strings are run on the content by identifying the beginning and end of the disclaimer body 208 and removing the disclaimer by removing all content from the beginning to the end of the identified disclaimer body 209. One or more matching disclaimer strings 205, 206, and 207 are run on the email document 203 after the font and text conversion steps 201 and 202. After all disclaimer strings have been run, the email document has either been unchanged, or the disclaimer sections removed per the instructions of the strings. One or more matching strings for classifying the email document are then run 211 before the process ends and the email document is classified.

In removing the legal disclaimer before the email document is analyzed the present invention teaches a two or three step approach.

The first step 205 involves finding key phrases that are at the beginning of a legal disclaimer. Examples include: “This email is not”; “This email and all attachments”; and “This message content”. When these key phrases are found in an electronic email document, they identify the beginning of a disclaimer.

In a second step 206, a string is run to find one or more terms that are in the body of the disclaimer such as: “Is prohibited” and “Is not permitted”. When these key phrases are found in an electronic email document, they identify the body of a disclaimer.

In a third step 207, a string is run to identify common ending language such as: “Delete”.

Any section of an electronic email document that meets the requirements of these three steps/strings is then edited by removing all content from the beginning to the end of the disclaimer body 209.

If the first matching disclaimer string 205 is found, that triggers a look for additional strings 206 and 207 and the process continues with running the search for a second matching disclaimer string 206 and there may be one or more additional strings 207 that will be found as this process can be repeated for any number of strings beyond two. The more matching disclaimer strings that are found, the more likely that the process has accurately found a disclaimer in the body of the email document and identified the beginning and end of the disclaimer body 208.

The method first searches for a first matching disclaimer string 205 and if it does not find a second matching disclaimer 206 the method ignores the result for the first matched disclaimer string 205 and does not remove anything from the email document. If a second legal disclaimer string 206 is found, the method will remove the identified disclaimer. If the method is able to apply and find a match to subsequent string, such as a third, fourth or fifth that match, there is a higher probability that a disclaimer has been properly located in the email document, so it depends on the precision of the user.

In a best mode of the present invention, the method looks for three strings 205, 206, and 207 to be sure a disclaimer has been properly identified in an email document. The number of disclaimer strings search can be varied and range from one to any plurality, but the results and accuracy must be measured for the method to properly function.

In another embodiment, the present invention can be configured to perform one or more matching disclaimer strings on an email document, but only remove the email document if a given percentage or a set number of matching disclaimer strings run on the email document have been found in the email document.

A very complete database of phrases is essential to accurately find the disclaimer. One technique that improves results is to identify the signature of the email and remove everything after that. When the method of the present invention combines these techniques, it has shown a very high probability solution.

The method taught by the present invention is set to run and/or executed on one or more computing devices. A computing device on which the present invention can run would be comprised of a CPU, hard disk drive, keyboard or other input means, monitor or other display means, CPU main memory or cloud memory, and a portion of main memory where the system resides and executes. Any general-purpose computer, tablet, smartphone, or equivalent device with an appropriate amount of storage space, display, and input is suitable for this purpose. Computer devices like this are well known in the art and are not pertinent to the invention.

In alternative embodiments, the method of the present invention can also be written or fixed in a number of different computer languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention.

Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The embodiments of the invention in which an exclusive property or privilege is claimed are defined as follows:

1. A method for email document classification executable by a machine and rendered on the display of the machine, comprising the steps of:
removing all html code from an email document;
converting the email text to a standardized all lower case font;
running one or more matching disclaimer strings on the email document;
running one or more matching strings on the content of the email document; and
classifying the email document.

2. The method of claim 1, further comprising the steps of
running two matching disclaimer strings are run on an email document;
identifying the beginning and end of the disclaimer; and
removing all content from the beginning to the end of the disclaimer body.

3. The method of claim 2, wherein the two matching disclaimer strings are:
finding and identifying key phrases that are at the beginning of a legal disclaimer; and
finding and identifying one or more terms that are in the body of the disclaimer.

4. The method of claim 3, further comprising a third matching disclaimer string:
finding and identifying common ending language; and
removing all content from the beginning to the ending language.

5. The method of claim 1, further comprising the steps of:
identifying the signature of the email document; and
remove everything after the signature in the email document.

6. The method of claim 1, wherein
the email document body is comprised of unique sender email content followed by a line break, signature, or other formatting commonality denoting where the message ends and where a disclaimer might begin.

7. A method for email document classification executable by a machine and rendered on the display of the machine, comprising the steps of:
removing all html code from an email document;
converting the email document text to a standardized all lower case font;
identifying disclaimer content by identifying the beginning and end of a disclaimer body;
removing the identified disclaimer;
running one or more matching strings on the content of the email document; and
classifying the email document.

8. A method for email document classification executable by a machine and rendered on the display of the machine, comprising the steps of:
removing all html code from an email document;
converting the email document text to a standardized all lower case font;
running one or more matching disclaimer strings on the email document;
identifying disclaimer content by identifying the beginning and end of a disclaimer body;
removing the identified disclaimer per the instructions of the strings;
running one or more matching strings on the content of the email document; and
classifying the email document.

9. The method of claim 8, further comprising the steps of:
running three matching strings on the content of the email document.

10. The method of claim 9, wherein
the first step involves finding key phrases that are at the beginning of a legal disclaimer; and
when these key phrases are found in an electronic email document, they identify the beginning of a disclaimer.

11. The method of claim 10, wherein
the second step involves finding one or more terms that are in the body of the disclaimer; and
when these key phrases are found in an electronic email document, they identify the body of a disclaimer.

12. The method of claim 11, wherein
a third step involves running a string is run to identify common ending language; and
when these key phrases are found in an electronic email document, they identify the end of a disclaimer.

13. The method of claim 12, wherein when any section of an electronic email document that meets the requirements of these three steps/strings is then edited by removing all content from the beginning to the end of the disclaimer body.

14. The method of claim 9, wherein
if the first matching disclaimer string is found, that triggers a look for additional strings and the process continues with running the search for a second matching disclaimer string.

15. The method of claim 10, wherein
if the second matching disclaimer string is found, that triggers a look for additional strings and the process continues with running the search for a third matching disclaimer string.

16. The method of claim 8, wherein
if the first matching disclaimer string is found, that triggers a look for additional strings and the process continues with running the search for a second matching disclaimer string;
this process is repeated for any number of strings beyond two; and
the repeating process ends when no matches to a disclaimer string are found.

17. The method of claim 8, further comprising the steps of:
searching for a first matching disclaimer string;
finding a first matched disclaimer string;
searching for a second matching disclaimer string;
failing to find a second matching disclaimer string result; and
retaining the email in its entirety with no removed language.

18. The method of claim 8, further comprising the steps of:
searching for a first matching disclaimer string;
finding a first matched disclaimer string;
searching for a second matching disclaimer string;
finding a second matching disclaimer string result; and
removing the identified disclaimer.

19. The method of claim 8, wherein
the number of disclaimer strings search can be varied and range from one to any plurality, but the results and accuracy must be measured.

20. The method of claim 8, wherein
performing one or more matching disclaimer strings on an email document;
removing the disclaimer from the email if a given percentage or a set number of matching disclaimer strings run on the email document have been found in the email document.
